(19) United States
(12) Patent Application Publication
(10) Pub. No.: US 2017/0111196 A1
(43) Pub. Date: Apr. 20, 2017

(54) METHOD OF EMBEDDING AUXILIARY INFORMATION INTO LEGACY PHYSICAL LAYER PREAMBLE

(71) Applicant: MEDIATEK INC., Hsin-Chu (TW)

(72) Inventor: Shih-Chang Su, Hsinchu County (TW)

(21) Appl. No.: 15/297,137

(22) Filed: Oct. 19, 2016

Related U.S. Application Data
(60) Provisional application No. 62/243,667, filed on Oct. 20, 2015.

(51) Int. Cl. H04L 27/26; H04W 84/12; H04L 1/00

(52) U.S. Cl. CPC H04L 27/2602; H04L 27/2692; H04L 1/0083; H04W 84/12

(57) ABSTRACT

A method for transmitting a legacy physical layer preamble of a frame that is to a wireless communication device, including: determining auxiliary information to be embedded into the legacy physical layer preamble; embedding the auxiliary information into at least one of a reserved field and a signal tail field of the legacy physical layer preamble; and transmitting the legacy physical layer preamble containing the auxiliary information to the wireless communication device.

### CROSS REFERENCE TO RELATED APPLICATIONS

This application claims the benefit of U.S. Provisional Application No. 62/243,667, field on Oct. 20, 2015. The entire contents of the related application are incorporated herein by reference.

### BACKGROUND

The present invention relates to wireless communication, and more particularly, to a method and apparatus of transmitting a legacy physical layer preamble, a method execution by a wireless communication device to operate in response to receipt of a legacy physical layer preamble and a wireless communication device thereof.

Wireless communication devices and systems operate under certain standards, such as IEEE 802.11 standard. As the standard has evolved from IEEE 802.11a, IEEE 802.11g to IEEE 802.11ac, and even IEEE 802.11ax, wireless communication devices that operate under earlier versions, such as, IEEE 802.11a, may reside in the same wireless local area network (WLAN) as devices that operate under newer versions, such as, IEEE 802.11ac do.

When legacy devices (which stand for devices that are compliant with and operate under earlier versions of IEEE 802.11 standard) reside in the same WLAN as newer devices (which stand for devices that are compliant with and operate under newer versions of IEEE 802.11 standard), it is necessary to ensure that the legacy devices know when the newer devices are utilizing the wireless channel.

Therefore, newer versions of IEEE 802.11 standard, such as IEEE 802.11n/ac/ax, introduces a legacy physical layer preamble (which is also referred to as L-SIG or spoofing physical layer convergence protocol (PLCP) preamble) to get PLCP level compatible to legacy devices, such as IEEE 802.11a/g compliant devices. The format of the legacy physical layer preamble follows definition in earlier versions of IEEE 802.11 standard, and therefore the legacy devices are able to decode the preamble portion of all received frames, obtaining sufficient information for determining whether the wireless channel is in use, thereby avoiding the legacy devices attempting to transmit over frames that are sent to and from the newer devices. In short, the purpose of the legacy physical layer preamble is only to allow newer devices to perform wireless communication operations without interference from legacy device.

However, since the legacy devices still fail to correctly decode the frames that are sent from the newer device because these frames still lack the backward compatibility at MAC level, MAC level IOP issues, such as network allocation vector (NAV) or virtual CS issues cannot be resolved, thereby causing high PER or hidden node issues. Also, this may lead to inefficient operations of the legacy devices.

### SUMMARY

In order to address the above-mentioned issues, it is one objective of the present invention to provide a method for a wireless apparatus. In this method, auxiliary information that comprises spoofing indicator, frame type, identity of an intended target of a frame, and/or checksum value, is embedded into the legacy physical layer preamble. Additionally, frame length information contained in a length field of the legacy physical layer preamble could be modified to extend channel occupation time such that the frame exchange process between newer devices can be fully protected against interference from legacy devices.

Further, it is still another objective of the present invention to provide a method for a wireless communication device to determine how to handle a portion of the frame according to the auxiliary information embedded in the legacy physical layer preamble. It is yet another objective of the present invention to provide a method for a wireless communication device to determine how to perform error control operation upon the received frame according to the auxiliary information embedded into the legacy physical layer preamble.

According to one embodiment of the present invention, a method is employed for transmitting a legacy physical layer preamble of a frame to a wireless communication device. The method comprises: determining auxiliary information to be embedded into a legacy physical layer preamble; embedding the auxiliary information into at least one of a reserved field and a signal tail field of the legacy physical layer preamble; and transmitting the legacy physical layer preamble containing the auxiliary information to a wireless communication device.

According to one embodiment of the present invention, an apparatus is employed for transmitting a legacy physical layer preamble of a frame to a wireless communication device. The apparatus comprises: a processing circuit and a transmitting circuit. The processing circuit is configured to determine auxiliary information to be embedded into the legacy physical layer preamble, and embed the auxiliary information into at least one of a reserved field and a signal tail field of the legacy physical layer preamble. The transmitting circuit is coupled to the processing circuit, and configured to transmit the legacy physical layer preamble containing the auxiliary information to the wireless communication device.

According to one embodiment of the present invention, a method for execution by a wireless communication device in response to receipt of a legacy physical layer preamble of a transmitted frame is provided. The method comprises: receiving a legacy physical layer preamble of the transmitted frame; and determining whether to receive or decode a remaining portion of the transmitted frame according to at least one of a reserved field and a signal tail field of the legacy physical layer preamble.

According to one embodiment, a method for execution by a wireless communication device is provided. The method comprises: receiving a legacy physical layer preamble of a transmitted frame; and controlling an error control operation in response to decoding failure regarding the transmitted frame according to at least one of a reserved field and a signal tail field of the legacy physical layer preamble.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates bit assignment of a legacy signal field defined in 802.11n/ac standard and how the present invention uses some fields thereof.

FIG. 2A and FIG. 2B illustrates PPDU frame format defined in IEEE 802.11n standard and IEEE 802.11ac standard, respectively.

FIG. 3 illustrates difference between duration of a frame and duration covers both the frame and an acknowledgement frame by different setting in the length field according to one embodiment of the present invention.

FIG. 4 illustrates a flow chart of a method of transmitting a legacy physical layer preamble to a wireless communication device according to one embodiment of the present invention.

FIG. 5 illustrates a block diagram an apparatus configured to transmit a legacy physical layer preamble to a wireless communication device according to one embodiment of the present invention.

FIG. 6 illustrates a flow chart of a method execution by a wireless communication device to operate in response to receipt of a legacy physical layer of a transmitted frame according to one embodiment of the present invention.

FIG. 7 illustrates a block diagram of a wireless communication device according to one embodiment of the present invention.

FIG. 8 illustrates a flow chart of a method execution by a wireless communication device to control an error control operation in response to decoding failure when receiving a transmitted frame according to one embodiment of the present invention.

### DETAILED DESCRIPTION

Certain terms are used throughout the following descriptions and claims to refer to particular system components. As one skilled in the art will appreciate, manufacturers may refer to a component by different names. This document does not intend to distinguish between components that differ in name but not differ in functionality. In the following discussion and in the claims, the terms “include”, “including”, “comprise”, and “comprising” are used in an open-ended fashion, and thus should be interpreted to mean “including, but not limited to . . . ” The terms “couple” and “coupled” are intended to mean either an indirect or a direct electrical connection. Thus, if a first device couples to a second device, that connection may be through a direct electrical connection, or through an indirect electrical connection via other devices and connections.

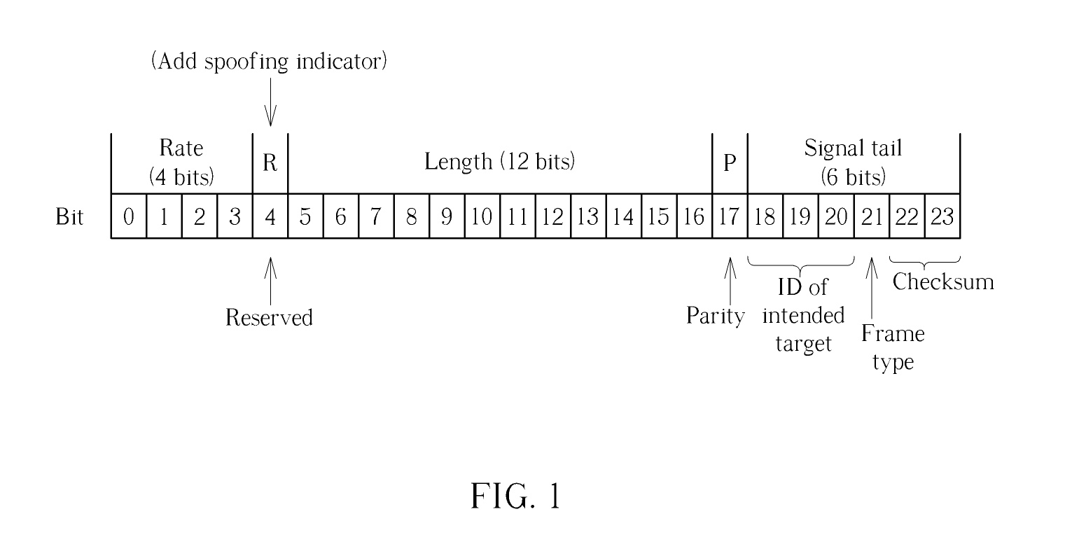

FIG. 1 illustrates bit assignment of a legacy signal (L-SIG) field defined in 802.11n/ac standard and how the present invention uses some field thereof to embed auxiliary information.

The L-SIG field in a PLCP protocol data unit (PPDU) frame in 802.11n/ac standard could be used to communicate rate and length information especially with legacy devices. In the L-SIG field, there are a rate field (bits 0-3) to indicate transmission rate of the PPDU frame, a reserved field (bit 4) which is typically set to 0 on transmit and ignored on receive, a length field (bit 5-16) to indicate a length of the PPDU frame, a parity field (bit 17) having the even parity of bits 0-16, and a signal tail (bits 18-23) field which is typically set to 0.

In one embodiment of the present invention, the reserved field (bit 4) of the L-SIG field could be set to logic 1 as a spoofing indicator to indicate the whole L-SIG field is a spoofing PLCP preamble, which also means the frame is intended for newer devices and there is another real physical layer preamble in the following portion of the frame.

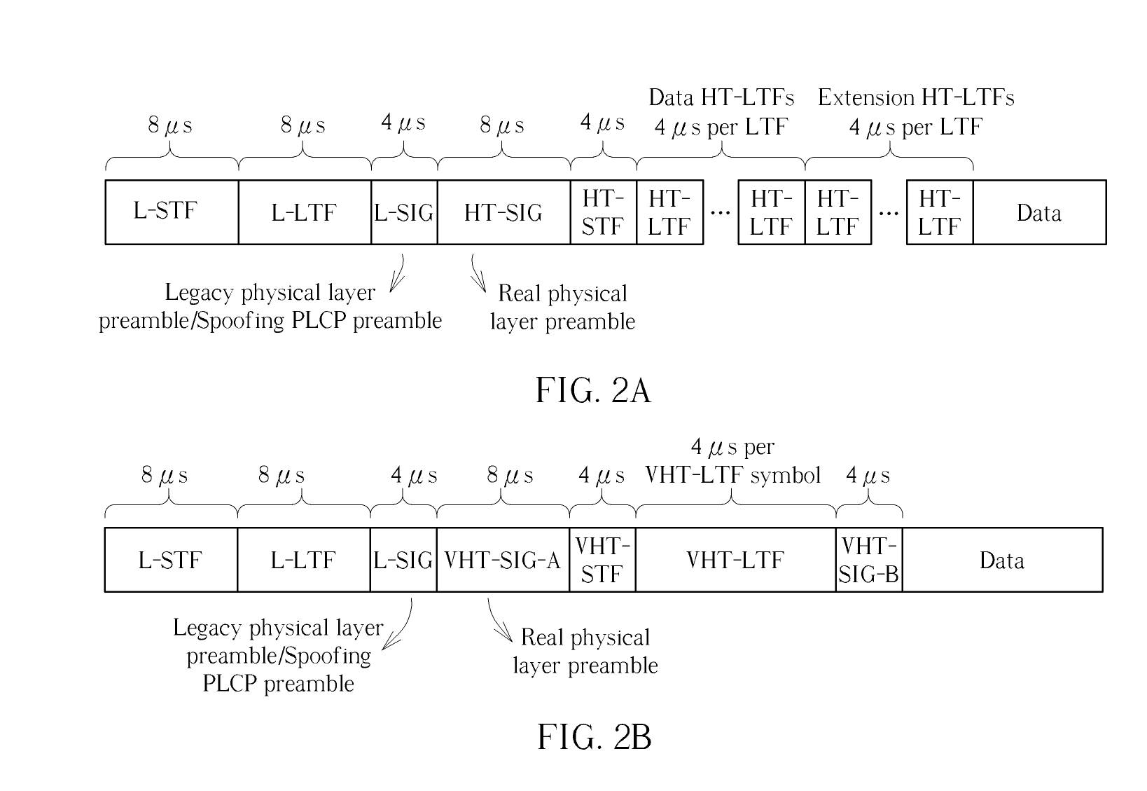

Please refer to FIG. 2A and FIG. 2B, which respectively illustrate a PPDU frame format defined in IEEE 802.11n standard and IEEE 802.11ac standard. As illustrated, both formats have real physical layer preambles for demodulating and decoding data part in the frame, which follows behind the spoofing PLCP preamble (i.e., L-SIG field). In other words, information contained in the L-SIG field is not necessary in demodulating and decoding data part in the frame, which is only intended to let legacy devices know this frame is wireless communication frame to avoid a collision.

When any device receives the L-SIG field and is able to recognize the spoofing indicator (e.g. logic 1 in the reserved field), it can comprehend the received L-SIG field is a spoofing PLCP preamble. For a legacy device that is able to recognize the spoofing indicator, it could ignore the remaining portion of the frame because the legacy device does not have the capability of correctly decoding the remaining portion of frame, thereby avoiding inefficient operations, such as error recovery.

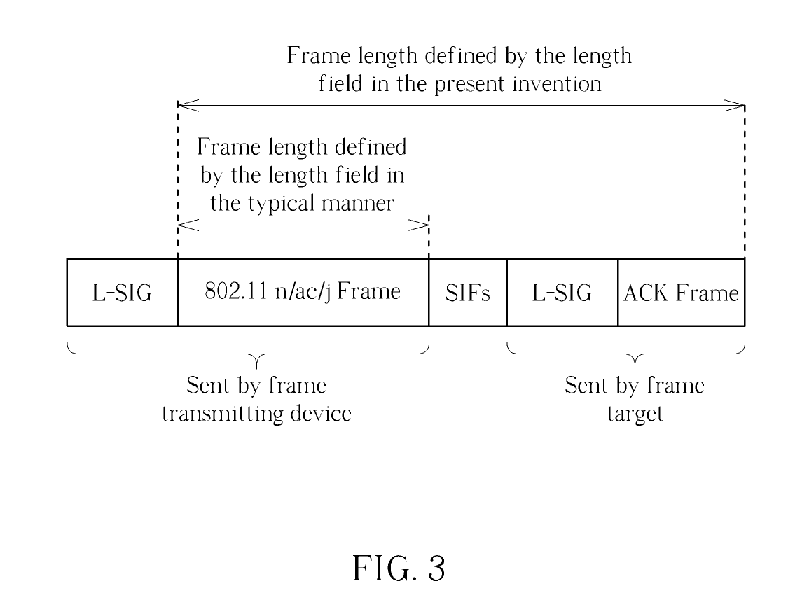

In one embodiment, frame length information contained in the length field (bits 5-16) could be modified to extend channel occupation time to protect the whole frame exchange between newer devices. Please refer to FIG. 3, which illustrates a difference between duration defined by the length field in a typical manner and a modification thereto. In the typical manner, frame length defined by the length field of refers to duration from an end of the L-SIG field to an end of the frame. Thus, any device coexist in the same WLAN will not attempt to access the wireless channel during the duration of the frame. Devices only contend for an access to the wireless channel after the end of the frame. However, in the newer versions of IEEE 802.11 standard, the end of the frame does not mean that the frame exchange between a frame transmitting device and a frame target has completed. The completion of the frame exchange should be at the time that the frame transmitting device successfully receives the acknowledgement frame sent back from the frame target. Hence, in order to avoid the wireless channel being taken up by other devices during the frame exchange to lead to inefficient frame exchange before the frame transmitting device receives an acknowledgement frame, the frame length information contained in the length field is extended to lengthen the channel occupation time. Such method is useful especially for avoiding the interference from the legacy devices because the legacy devices only recognizes the end of the frame from the length field but does not comprehend whether the frame exchange has been finished. In the present invention, the frame length information in the length field is set to define a duration covering both the frame itself and an acknowledge frame sent from the frame target as shown by lower part of FIG. 3. As a result, it can be ensured that no other device will contend for an access to the wireless channel immediately after the end of the frame. Each device coexist in the same WLAN will deem the time when the frame transmitting device receives the acknowledgement frame as the end of the frame. Therefore, the whole process of frame exchange can be fully protected.

In one embodiment, a portion of bits in the signal tail field will be used encode information that is associated with an identity of an intended target of the frame. For example, bits 18-20 in the signal tail field could be used to reveal information that is associated with a destination address of contained in a MAC header to identify the intended target of the transmitted frame. In this way, when a device receives the L-SIG field and recognizes the identity of the intended target indicated by the bits in the signal tail field does not match to itself, the device can stop either receiving or decoding remaining portion of the frame. Furthermore, the device can even power down either the receiving circuit not to receive the remaining portion of the frame or the decoding circuit to stop decoding the remaining portion of the frame, thereby getting better power efficiency.

In one embodiment, one or more bits in the signal tail field can be used to encode information that indicates a frame type of the transmitted frame. For example, such information can indicate the frame is either a data frame or a control frame (e.g. an acknowledgement frame). For special purposes, a device may ignore the control frame or the data frame, and only responds to one of them. Hence, once it is found the frame type of the frame indicated by bits of the signal tail field correspond to a certain type, the device can determine whether to continue to handle the remaining portion of the frame.

In one embodiment, one or more bits in the signal tail field will be used to encode checksum value computed over the L-SIG field. When these bits combined with the bit in the parity field (bit 17), it is more robust in error detection.

Please note that certain numbers of bits are mentioned to encode the auxiliary information in the above-mentioned embodiments. However, this is not intended to limit the scope of the invention in these numbers of bits. Depending on different requirements, various numbers of bits may be used to encode the auxiliary information. Additionally, the above-mentioned embodiments provide several ways of embedding auxiliary information into L-SIG field. These embodiments may be implemented solely or in combination with other embodiments. For example, it is possible to contain a spoofing indicator in the reserved field as well as contain information that is associated with an intended target of the frame in a same legacy physical layer preamble. Alternatively, it is also possible to contain a spoofing indicator only, in one legacy physical layer preamble, while contain information that is associated with an intended target of the frame only, in another legacy physical layer preamble.

Embodiments disclosed in the following are method and apparatus of embedding information into a legacy physical layer preamble (e.g. L-SIG field) and transmitting the legacy physical layer preamble.

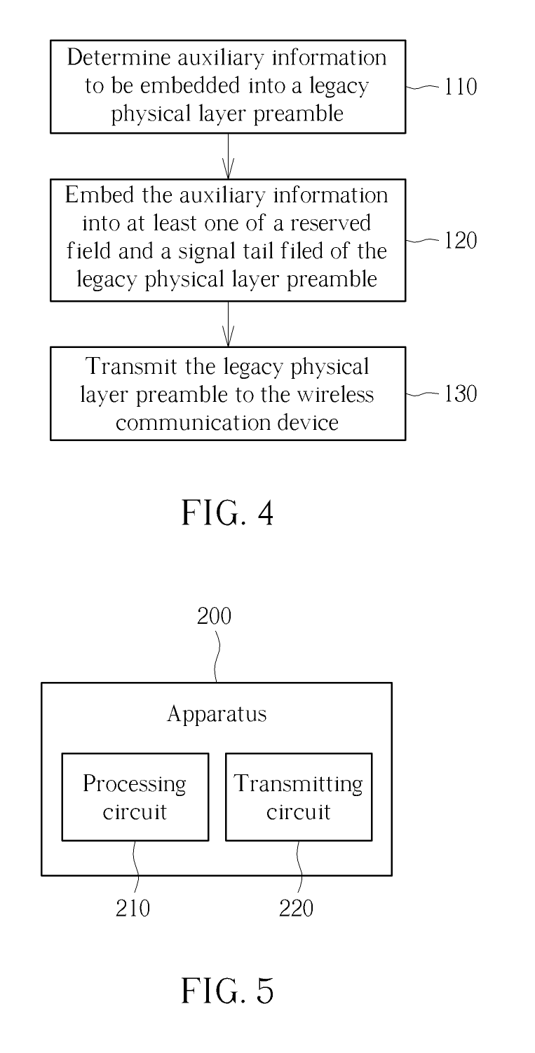

FIG. 4 illustrates a flow chart of a method for transmitting a legacy physical layer preamble of a frame according to one embodiment of the present invention. As shown by FIG. 4, in step 110, it is determined what auxiliary information will be embedded into the legacy physical layer preamble. Then, in step 120, the auxiliary information is embedded into at least one of a reserved field and a signal tail field of the legacy physical layer preamble. Consequently, in step 130, the legacy physical layer preamble containing the auxiliary information is transmitted to the wireless communication device. Further details of this method will be elaborated in conjunction with embodiments illustrated by FIG. 5.

Based on the above-mentioned method, an apparatus for transmitting a legacy physical layer preamble of a frame is provided. Please refer to FIG. 5, which illustrates a block diagram of an apparatus for transmitting a legacy physical layer preamble of a frame to a wireless communication device according to one embodiment of the present invention. As shown by FIG. 5, an apparatus 200 comprises a processing circuit 210 and a transmitting circuit 220. The processing circuit 210 is configured to determine what auxiliary information is to be embedded into the legacy physical layer preamble, and further embed the auxiliary information into at least one of a reserved field and a signal tail field of the legacy physical layer preamble. For example, the processing circuit 210 may determine to embed a spoofing indicator into a reserved field of the L-SIG field, embed information that indicates a frame type of the frame into a signal tail field of the L-SIG field, embed information that is associated with an identity of an intended target of the frame into signal tail field and/or embed a checksum value that is associated with the frame into the signal tail field. Once the auxiliary information to be embedded is determined, the processor circuit 210 uses one or more bits in the above-mentioned fields to encode the determined auxiliary information thereby to generate the legacy physical layer preamble containing the above-mentioned auxiliary information. Further, the processing circuit 210 may also determine to set the frame length information in the length field to cover the duration of both the frame to be transmitted and the acknowledgement frame. After that, the transmitting circuit 220 transmits the generated legacy physical layer preamble to one or more wireless communication devices.

Embodiments disclosed in the following provide method regarding how a wireless communication device operates in response to receipt of the legacy physical layer preamble containing the above-mentioned auxiliary information, and the wireless communication device thereof.

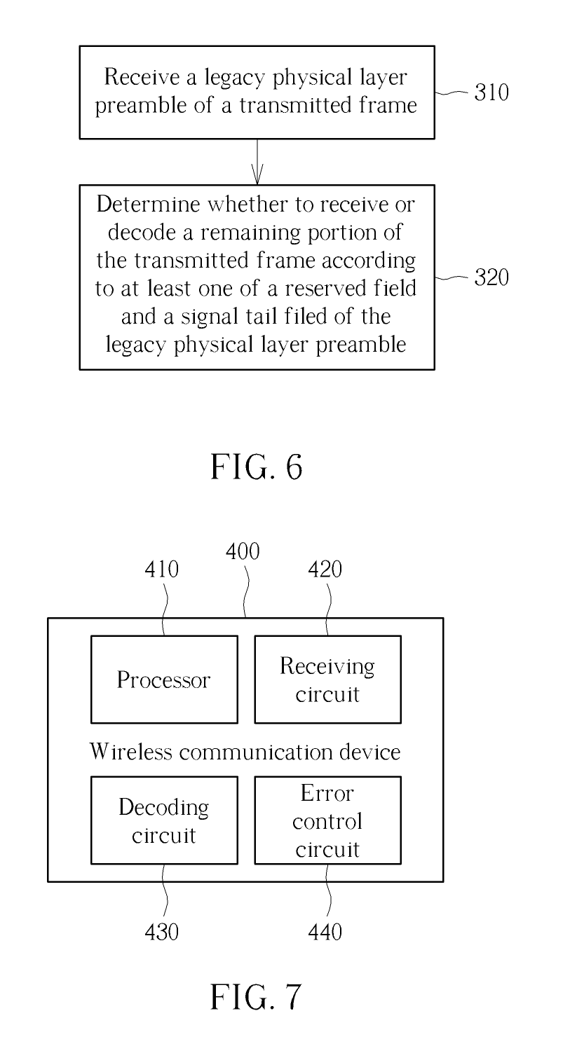

FIG. 6 illustrates a flow chart of a method for execution by a wireless communication device according to one embodiment of the present invention. The method is executed to instruct the wireless communication device how to operate in response to receipt of a legacy physical layer preamble of a transmitted frame. In step 310 of the flow, a legacy physical layer preamble of the transmitted frame is received. Then, in step 320, it is determined whether to receive or decode a remaining portion of the transmitted frame according to at least one of a reserved field and a signal tail field of the legacy physical layer preamble. Further details of this method will be elaborated in conjunction with the embodiment illustrated by FIG. 7.

FIG. 7 illustrates a block diagram of a wireless communication device according to one embodiment of the present invention. As shown by FIG. 7, a wireless communication device 400 comprises: a processing circuit 410 and a receiving circuit 420. The receiving circuit 420 is configured to receive a legacy physical layer preamble of a transmitted frame and the transmitted frame. After the legacy physical layer preamble is received and decoded, but before receiving of the transmitted frame is completed, the processing circuit 410 is configured to determine whether the receiving circuit 420 needs to receive or a decoding circuit 430 needs to decode a remaining portion of the transmitted frame according to at least one of a reserved field and a signal tail field of the legacy physical layer preamble. For example, the processing circuit 410 could determine to control the receiving circuit 420 not to receive or control the decoding circuit 430 not to decode the remaining portion of the transmitted frame when detecting a spoofing indicator is contained in a reserved field of legacy physical layer preamble. When one or more bits in a signal tail field of legacy physical layer preamble contains information that indicates a frame type of the transmitted frame, the processing circuit 420 could determine to control the receiving circuit 420 not to receive or control the decoding circuit 430 not to decode the remaining portion of the transmitted frame when detecting the frame type of the transmitted frame corresponds to a specific type. When one or more bits in the signal tail field of the legacy physical layer preamble contains information that is associated with an intended target of the transmitted frame, the processing circuit 420 could determine to control the receiving circuit 420 not to receive or control the decoding circuit 430 not to decode the remaining portion of the transmitted frame when detecting the information that is associated with the intended target of the transmitted frame does not match to the identity of the wireless communication device 400.

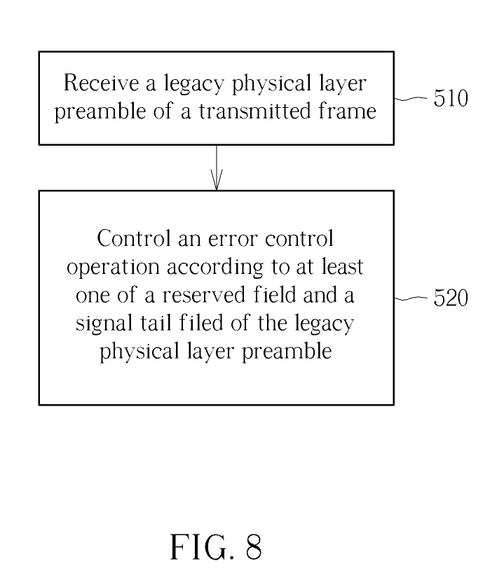

FIG. 8 illustrates a flow chart of another method that could be executed by the wireless communication device 400, which is related to error control part in the wireless communication device 400. As shown by FIG. 8, in step 510, the receiving circuit 420 receives a legacy physical layer preamble of a transmitted frame. Once decoding failure happens when the decoding circuit 430 decodes the received portion of the transmitted frame, the processing circuit 410 could determine how to control an error control operation according to at least one of a reserved field and a signal tail field of the legacy physical layer preamble (step 520). In one embodiment, the processing circuit 410 could determine to control an error control circuit 440 not to perform an error correction/recovery operation in response to the decoding failure when detecting the spoofing indicator in the reserved field. In one embodiment, one or more bits in the signal tail field of the legacy physical layer preamble could contain information that indicates a frame type of the transmitted frame. The processing circuit 410 could determine to control an error control circuit 440 not to perform an error correction/recovery operation in response to the decoding failure when detecting the frame type of the transmitted frame corresponds to a specific type. In one embodiment, one or more bits in the signal tail field of the legacy physical layer preamble contain information that is associated with an intended target of the transmitted frame. The processing circuit 410 could determine to control the error control circuit 440 not to perform the error correction/recovery operation in response to the decoding failure when the information that is associated with the intended target of the transmitted frame does not match to the identity of the wireless communication device 400. In one embodiment, one or more bits in the signal tail field of legacy physical layer preamble contain a checksum value that is associated with the transmitted frame. The processing circuit 410 could control the error control circuit 440 to perform the error detection operation according to the checksum value (in conjunction with parity check bit) contained in the one or more bits in the signal tail field.

The embedded auxiliary information could be used in conjunction with other information to allow the wireless communication device to perform some intelligent decisions and behaviors.

For example, when a device detects the signal intensity of the received legacy physical layer preamble of a frame is weak, the device could confirm that the frame transmitting device is not located around the neighboring area. In addition, the device could also obtain the information that is associated with the intended target of the frame from the received legacy physical layer preamble. If the device does not hear a destination address (from previous transmitted frames) similar to or matching to the information contained in the legacy physical layer preamble. The device can determine the frame intended target is also not located around the neighboring area. Hence, the device may use the wireless channel for sending another frame without causing a collision.

Another example is to ignore some frames and proceed to handle other frame transmitted over the previous frames. A device ignores a frame only when the device confirms that it is not an intended target according to the destination address in the MAC header. However, in an overlapped network, if the device receives a legacy physical layer preamble of a first frame sent from a first frame transmitting device and it also hears a second frame that is sent from a second frame transmitted device (assuming that the second frame transmitting device is not aware of the first frame transmitting is using the wireless channel). The device can ignore the first frame and proceed to handle the second frame once it confirmed that the indented target information contained in a legacy physical layer preamble of the first frame does not match to itself.

Yet another example is related to error control. For example, it is possible for the legacy device to have a decoding success of a frame of newer versions of IEEE 802.11 standard at PHY level. However, the legacy devices will fail to decode MAC level data eventually. The legacy device may apply extended inter-frame space (EIFS) procedure to have an attempt on error recovery as the legacy devices deem the decoding failure is recoverable. However, as the MAC level data is encoded in a format compliant with newer versions of IEEE 802.11 standard, this is impossible for the legacy devices to correctly decode the MAC level data by just applying error recovery operation. Therefore, the ELFS applied by the legacy device is unnecessary and inefficient. In order to avoid such condition, if the spoofing indicator in the legacy physical layer preamble is comprehendible to the legacy device, the legacy device can determine not to apply the EIFS procedure when encountering the MAC level decoding failure.

Reference in the specification to “one embodiment” or “an embodiment” means that a particular feature, structure, or characteristic described in connection with the embodiment is included in at least an implementation. The appearances of the phrase “in one embodiment” in various places in the specification are not necessarily all referring to the same embodiment. Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

An embodiment of the invention may include functionality that may be implemented as software executed by a processor, hardware circuits or structures, or a combination of both. The processor may be a general-purpose or dedicated processor. The software may comprise programming logic, instructions or data to implement certain functionality for an embodiment of the invention. The software may be stored in a medium accessible by a machine or computer-readable medium, such as read-only memory (ROM), random-access memory (RAM), magnetic disk (e.g., floppy disk and hard drive), optical disk (e.g., CD-ROM) or any other data storage medium. In one embodiment of the invention, the media may store programming instructions in a compressed and/or encrypted format, as well as instructions that may have to be compiled or installed by an installer before being executed by the processor. Alternatively, an embodiment of the invention may be implemented as specific hardware components that contain hard-wired logic for performing the recited functionality, or by any combination of programmed general-purpose computer components and custom hardware components.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for a wireless apparatus, the method comprising:
determining auxiliary information to be embedded into a legacy physical layer preamble;
embedding the auxiliary information into at least one of a reserved field and a signal tail field of the legacy physical layer preamble; and
transmitting the legacy physical layer preamble containing the auxiliary information to a wireless communication device.

2. The method of claim 1, wherein the step of embedding the auxiliary information into the legacy physical layer preamble comprises:
using a bit in the reserved field of the legacy physical layer preamble to encode the auxiliary information that indicates the legacy physical layer preamble is a spoofing preamble for a wireless communication device.

3. The method of claim 1, further comprising:
using bits in the length field of the legacy physical layer preamble to encode an indicative length that covers a duration from an end of the legacy physical layer preamble to an end of an acknowledgement frame sent from a wireless communication device.

4. The method of claim 1, wherein the step of embedding the auxiliary information into the legacy physical layer preamble comprises:
using at least one of bits in the signal tail field of the legacy physical layer preamble to encoded the auxiliary information that indicates a frame type of the frame.

5. The method of claim 1, wherein the step of embedding the auxiliary information into the legacy physical layer preamble comprises:
using at least one of bits in the signal tail field of the legacy physical layer preamble to encode a checksum value that is associated with the legacy physical layer preamble.

6. The method of claim 1, wherein the step of embedding the auxiliary information into the legacy physical layer preamble comprises:
using at least one of bits in the signal tail field of the legacy physical layer preamble to encode the auxiliary information that is associated with an identity of an intended target of the frame.

7. An apparatus for transmitting a legacy physical layer preamble of a frame to a wireless communication device, comprising:
a processing circuit, configured to determine auxiliary information to be embedded into the legacy physical layer preamble, and embed the auxiliary information into at least one of a reserved field and a signal tail field of the legacy physical layer preamble; and
a transmitting circuit, coupled to the processing circuit, and configured to transmit the legacy physical layer preamble containing the auxiliary information to the wireless communication device.

8. The apparatus of claim 7, wherein the processing circuit uses a bit in the reserved field of the legacy physical layer preamble to encode the auxiliary information that indicates the legacy physical layer preamble is a spoofing preamble for the wireless communication device.

9. The apparatus of claim 7, wherein the processing circuit further uses bits in the length field of the legacy physical layer preamble to encode an indicative length that covers a duration from an end of the legacy physical layer preamble to an end of an acknowledgement frame sent from the wireless communication device.

10. The apparatus of claim 7, wherein the processing circuit uses at least one of bits in the signal tail field of the legacy physical layer preamble to encode the auxiliary information that indicates a frame type of the frame.

11. The apparatus of claim 7, wherein the processing circuit uses at least one of bits in the signal tail field of the legacy physical layer preamble to encode a checksum value that is associated with the legacy physical layer preamble.

12. The apparatus of claim 7, wherein the processing circuit uses at least one of bits in the signal tail field of the legacy physical layer preamble to encode the auxiliary information that is associated with an identity of an intended target of the frame.

13. A method for a wireless communication device, the method comprising:
receiving a legacy physical layer preamble of a transmitted frame; and
determining whether to receive or decode a remaining portion of the transmitted frame according to at least one of a reserved field and a signal tail field of the legacy physical layer preamble.

14. The method of claim 13, wherein the step of determining whether to receive or decode the remaining portion of the transmitted frame comprises:
determining not to receive or decode the remaining portion of the transmitted frame when detecting a spoofing indicator is contained in the reserved field of the legacy physical layer preamble.

15. The method of claim 13, wherein one or more bits in the signal tail field of the legacy physical layer preamble contain information that indicates a frame type of the transmitted frame, and the step of determining whether to receive or decode the remaining portion of the transmitted frame comprises:
determining not to receive or decode the remaining portion of the transmitted frame when detecting the frame type of the transmitted frame corresponds to a specific type.

16. The method of claim 13, wherein one or more bits in the signal tail field of the legacy physical layer preamble contains information that is associated with an intended target of the transmitted frame, and the step of determining whether to receive or decode the remaining portion of the transmitted frame comprises:
determining not to receive or decode the remaining portion of the transmitted frame when detecting the information that is associated with the intended target of the transmitted frame does not match to an identity of the wireless communication device.

17. A method for a wireless communication device, the method comprising:
receiving a legacy physical layer preamble of a transmitted frame; and
performing an error control operation according to at least one of a reserved field and a signal tail field of the legacy physical layer preamble.

18. The method of claim 17, wherein the step of performing the error control operation comprises:
determining not to perform an error correction/recovery operation in response to decoding failure regarding the transmitted frame when detecting a spoofing indicator is contained in the reserved field of the legacy physical layer preamble.

19. The method of claim 17, wherein one or more bits in the signal tail field of the legacy physical layer preamble contains information that indicates a frame type of the transmitted frame, and the step of controlling the error control operation comprises:
determining not to perform an error correction/recovery operation in response to decoding failure regarding the transmitted frame when detecting the frame type of the transmitted frame corresponds to a specific type.

20. The method of claim 17, wherein, one or more bits in the signal tail field of the legacy physical layer preamble contains information that is associated with an intended target of the transmitted frame, and the step of controlling the error control operation comprises:
determining not to perform the error correction/recovery operation in response to decoding failure regarding the transmitted frame when the information that is associated with the intended target of the transmitted frame does not match to an identity of the wireless communication device.

21. The method of claim 17, wherein one or more bits in the signal tail field of the legacy physical layer preamble contains a checksum value that is associated with the transmitted frame, and the step of controlling the error control operation comprises:
performing the error detection operation according to the checksum value contained in the one or more bits in the signal tail field of the legacy physical layer preamble.
